(19) United States
(12) Patent Application Publication
(10) Pub. No.: US 2005/0006973 A1
(43) Pub. Date: Jan. 13, 2005

(54) Twin coil claw pole rotor with five-phase stator winding for electrical machine

(76) Inventors: Michael D. Bradfield, Anderson, IN (US); Duane J. Buening, Fishers, IN (US)

Correspondence Address: James J. Merrick;Cantor Colburn LLP, 55 Griffin Road South, Bloomfield, CT, 06002, US

(21) Appl. No.: 10/714,135

(22) Filed: Nov. 14, 2003

Related U.S. Application Data
(60) Provisional application No. 60/485,610, filed on Jul. 7, 2003.

(51) Int. Cl. H02K 1/00

(52) U.S. Cl. 310/180

(57) ABSTRACT

A dynamoelectric machine including a stator including a stator winding consisting of five phases inserted in a plurality of slots defining the stator; and a rotor rotatable within the stator, a rotor composed of more than two flux carrying segments, each segment having P/2 claw poles, wherein P is an even number.

### CROSS REFERENCE TO RELATED APPLICATION

This application claims the benefit of U.S. Provisional Application No. 60/485,610, filed Jul. 7, 2003 the contents of which are incorporated by reference herein in their entirety.

### TECHNICAL FIELD

This application relates generally to an electrical apparatus. More specifically, this application relates to a twin coil rotor for an electrical machine and enhancing output and efficiency of the same. The application also relates to a twin coil rotor for an electrical machine and a system to reduce emitted noise, particularly magnetic noise.

### BACKGROUND

Electrical loads for vehicles continue to escalate. At the same time, the overall package size available for the electrical generator continues to shrink. Consequently there is a need for a higher power density system and method of generating on-board electricity.

In addition, it is desired to reduce the underhood noise associated with a three-phase alternating current (AC) produced by an alternator. The three-phase alternating current is rectified into a direct current, which can be stored in a battery of a vehicle or be used directly by the electrical circuit of the vehicle which is supplied with a direct current (DC) voltage.

It is known in the art relating to alternating current (AC) generators to utilize a conventional, thirty-six slot/tooth stator twelve rotor pole 3-phase configuration alternator to furnish a vehicle's electrical system with an appropriate supply of current to meet the electrical demands of the vehicle. These three phase generator designs are known to produce a significant amount of magnetic noise while being operated.

In an effort to reduce the magnetic noise of the conventional three phase generator, an alternative alternating current generator design having two sets of three-phase windings, has been effectively used. Such a generator requires a seventy-two slot/tooth stator which is expensive to manufacture and difficult to wind.

The need exists to further reduce the level of magnetic noise produced by AC generators, particularly those used in vehicle applications, improve electrical efficiency and reduce manufacturing cost.

### BRIEF SUMMARY OF THE INVENTION

The above-discussed and other drawbacks and deficiencies are overcome or alleviated by a dynamoelectric machine including a stator including a stator winding consisting of five phases inserted in a plurality of slots defining the stator; and a rotor rotatable within the stator, a rotor composed of more than two flux carrying segments, each segment having P/2 claw poles, wherein P is an even number.

In an exemplary embodiment, the stator winding is operably connected to a corresponding five-phase rectifier and a coil winding is disposed intermediate each of the more than two flux carrying segments, wherein each coil winding is energized providing a first magnetic polarity on outbound claw poles defining the rotor and a second polarity opposite the first polarity on claw poles intermediate the outbound claw poles.

### BRIEF DESCRIPTION OF THE DRAWINGS

FIG. 1 is a sectional view of an AC generator incorporating a stator assembly and a twin coil three segment claw pole rotor assembly constructed in accordance with the present invention;

FIG. 2 is a perspective view of the rotor assembly of FIG. 1;

FIG. 3 is a circuit diagram of an exemplary embodiment of a stator assembly of FIG. 1 having a five-phase stator winding in operable communication with a corresponding five-phase bridge rectifier and the twin coil rotor assembly;

FIG. 4 is a schematic view illustrating a pentagon connection scheme for the 5-phase windings of FIG. 3; and

FIG. 5 is a schematic view of the stator slot/teeth illustrating a general 5-phase winding of the stator in accordance with the invention wherein a reverse progressive wind of the wire is used.

### DESCRIPTION OF THE PREFERRED EMBODIMENT

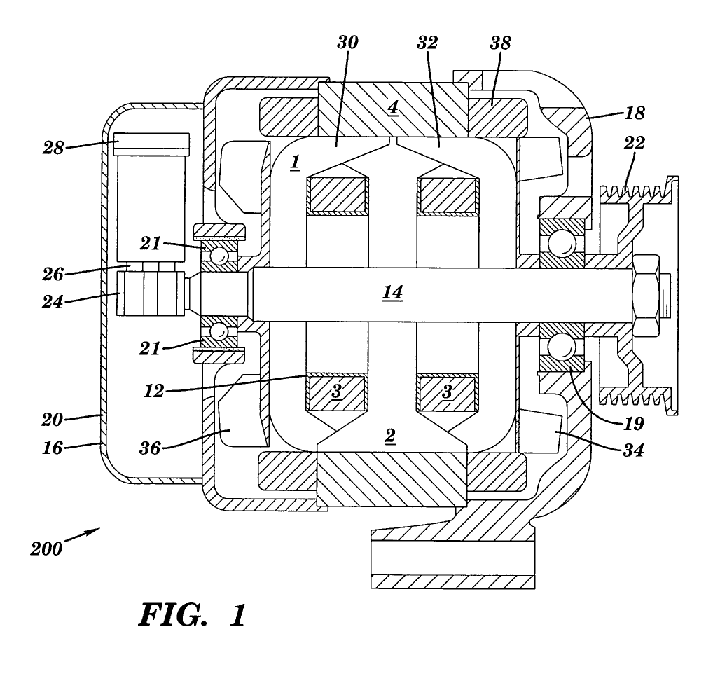

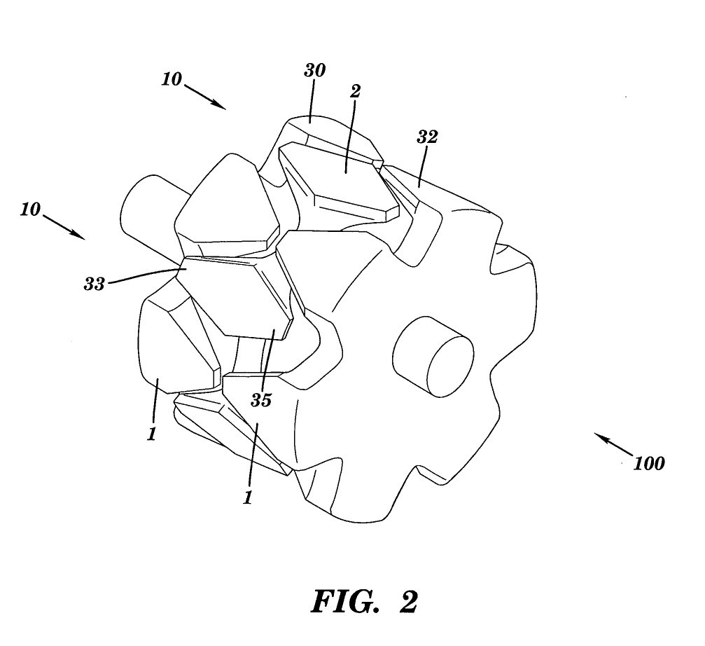

Referring to FIGS. 1 and 2, an exemplary embodiment of a rotor assembly 100 having three claw pole segments is illustrated. The two outbound claw pole segments, or end segments 1, are aligned with each other such that they point towards each other and define a width of the rotor assembly 100. Each end segment 1 has P/2 claw poles where P is an even number and representative of the total number of poles. A third, and center claw pole segment 2 is disposed intermediate end segments 1. Center claw pole segment 2 has poles that project toward the outbound claw pole segments 1 and is typically symmetrical about its center. More specifically, each pole of center claw pole segment 2 extends between a gap 10 created between contiguous claw poles of each end segment 1. Center claw pole segment 2 also has P/2 claw poles where P is an even number corresponding to P for the number of P/2 claw poles of each end segment 1. It will be noted that outbound end claw pole segments 1 are disposed on an outer circumferential edge at a uniform angular pitch in a circumferential direction so as to project axially, and each of the opposing claw pole segments 1 are fixed to shaft 14 facing each other such that the end segment claw-shaped magnetic poles would intersect if they were extended. Furthermore, center claw pole segment 2 is disposed in gap 10 defined by contiguous segments 1 such that a pair of opposing first and second claw-shaped magnetic poles 33 and 35 extending axially defining a circumferential periphery of each center pole segment intermesh with claw-shaped magnetic poles 30 and 32 defining end segments 1.

A field coil winding 3 is located between each end pole segment 1 on a corresponding bobbin 12 for a total of two field coil windings 3. The field coil windings 3 are energized such that the magnetic polarity of the outbound or end pole segments 1 are the same and opposite the center pole segment 2. Such an arrangement for the field rotor produces a stronger rotating magnetic field and allows the axial length of a stator 4 to be more effectively lengthened compared to a claw-pole alternator. It will be recognized by one skilled in the pertinent art that permanent magnets can be placed between the claw pole segments 1, 2 to further enhance output and efficiency of the stator 4 and rotor assembly 100.

Referring now to FIG. 1, rotor assembly 100 is disposed in a dynamoelectric machine 200 that operates as an alternator in an exemplary embodiment, but not limited thereto, and is constructed by rotatably mounting a claw-pole rotor or rotor assembly 100 by means of a shaft 14 inside a case 16 constituted by a front bracket 18 and a rear bracket 20 made of aluminum and fixing stator 4 to an inner wall surface of the case 16 so as to cover an outer circumferential side of the rotor assembly 100.

The shaft 14 is rotatably supported in the front bracket 18 via bearing 19 and the rear bracket 20 via bearing 21. A pulley 22 is fixed to a first end of this shaft 14, enabling rotational torque from an engine to be transmitted to the shaft 14 by means of a belt (not shown).

Slip rings 24 for supplying an electric current to the rotor assembly 100 are fixed to a second end portion of the shaft 14, a pair of brushes 26 being housed in a brush holder 28 disposed inside the case 16 so as to slide in contact with these slip rings 24. A voltage regulator (not shown) for adjusting the magnitude of an alternating voltage generated in the stator 4 is operably coupled with the brush holder 28.

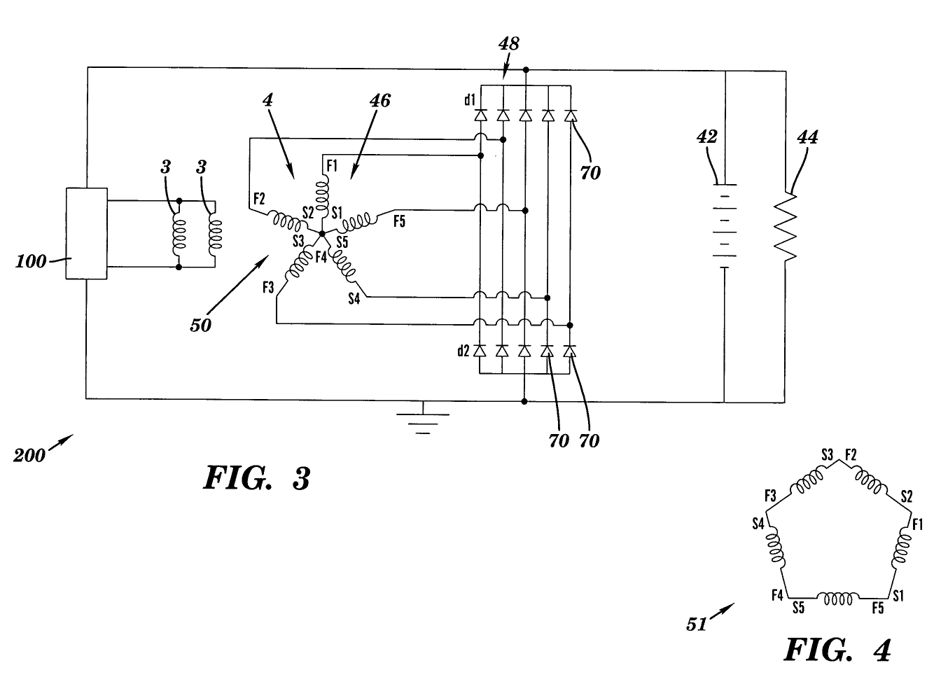

A rectifier 48 (see FIG. 3) for converting alternating current generated in the stator 4 into direct current is mounted inside case 16, the rectifier 48 being constituted by a five-phase full-wave rectifier in which five diode pairs, respectively, are connected in parallel, each diode pair being composed of a positive-side diode d₁ and a negative-side diode d₂ connected in series (see FIG. 3). Output from the rectifier 48 can be supplied to a storage battery 42 and an electric load 44. Rectifier 48 converts alternating current generated in stator 4 into direct current and is mounted inside case 16.

As described above, the rotor assembly 100 is constituted by: the pair of field windings 3 for generating a magnetic flux on passage of an electric current; and pole cores or segments 1 and 2 disposed so as to cover the field windings 3, magnetic poles being formed in the segments 1 and 2 by the magnetic flux generated by the field windings 3. The end and center segments 1 and 2, respectively, are preferably made of iron, each end segment 1 having two first and second claw-shaped magnetic poles 30 and 32, respectively, disposed on an outer circumferential edge and aligned with each other in a circumferential direction so as to project axially, and the end segment pole cores 30 and 32 are fixed to the shaft 14 facing each other such that the center segment core is therebetween the claw-shaped end segment magnetic poles 30 and 32 and intermesh with the magnetic poles 33 and 35 of center segment 2, respectively, as best seen in FIG. 2.

Still referring to FIG. 1, fans 34 and 36 (internal fans) are fixed to first and second axial ends of the rotor assembly 100. Front-end and rear-end air intake apertures (not shown) are disposed in axial end surfaces of the front bracket 18 and the rear bracket 20, and front-end and rear-end air discharge apertures (not shown) are disposed in first and second outer circumferential portions of the front bracket 18 and the rear bracket 20 preferably radially outside front-end and rear-end coil end groups of the armature winding 38 installed in the stator core 4.

In the dynamoelectric machine 200 constructed in this manner, an electric current is supplied to the twin field windings 3 from the storage battery through the brushes 26 and the slip rings 24, generating a magnetic flux. The first claw-shaped magnetic poles 30 and 32 of the end segments 1 are magnetized into a fixed polarity by this magnetic flux (such as North seeking (N) poles), and the center claw-shaped magnetic poles 33 and 35 are magnetized into the opposite polarity (such as South-seeking (S) poles). At the same time, rotational torque from the engine is transmitted to the shaft 14 by means of the belt (not shown) and the pulley 22, rotating the rotor assembly 100. Thus, a rotating magnetic field is imparted to the armature winding 38, inducing a voltage across the armature winding 38.

Referring now to FIG. 3, the dynamoelectric machine 200 is illustrated as a circuit diagram. This alternating-current electromotive force passes through a rectifier 40 and is converted into direct current, the magnitude thereof is adjusted by the voltage regulator (not shown), a storage battery 42 is charged, and the current is supplied to an electrical load 44.

Along with electrical load escalation, is a continuing trend of lower allowable underhood noise, particularly magnetic noise. To address this concern, the stator 4 of this invention includes a 5-phase winding 46 depicted schematically in FIG. 3. The 5-phase winding is connected to a 5-phase rectifier 48.

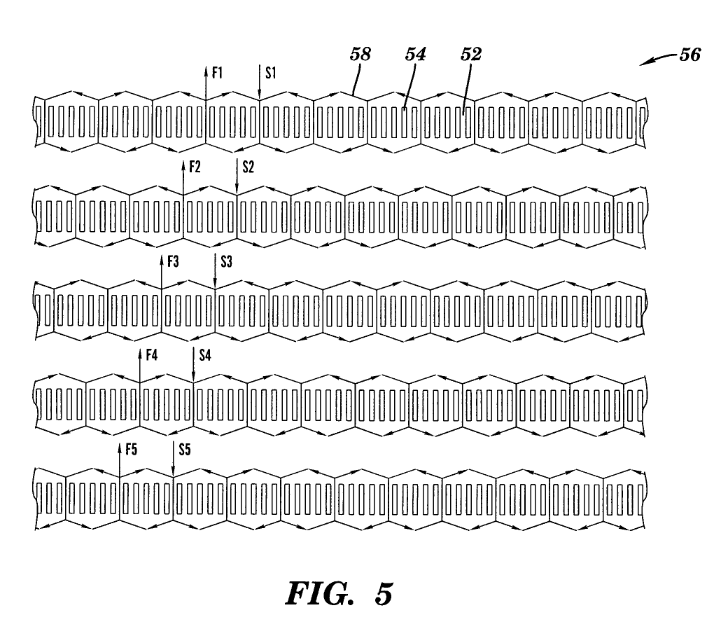

Referring to FIGS. 3 and 5, an exemplary stator assembly 26 includes five-phase winding 46 with each phase being offset 72 electrical degrees, distributed through and among the stator slots 52 so that a five-phase alternating current is obtained by twelve magnetic poles of the rotor assembly 100. In accordance with the invention the number of stator slots, S, is represented as follows:
S=10np
where n is any integer (1 in the preferred embodiment), and p is the number of rotor pole pairs (any positive integer, six pairs shown in FIG. 2).

In a generic embodiment of the invention illustrated in FIG. 5, for example, 5-phase stator winding 46 is wound onto a 60 slot/tooth stator 4 by winding an enameled copper wire 58 beginning at S1 and winding around five stator teeth 54, then advancing five stator teeth and winding around the next five stator teeth and repeating this pattern until all the stator teeth are wound, completing one phase, and the wire is brought out at F1. A second phase of the 5-phase windings is similarly wound beginning at S2 which is two stator slots advanced from the beginning winding of the first set of 5-phase windings, S1, finishing at F2. A third phase of the 5-phase winding is similarly wound beginning at S3 which is two stator slots advanced from the beginning winding of the second set a 5-phase windings, S2, finishing at F3. A fourth phase of the 5-phase winding is similarly wound beginning at S4 which is two stator slots 52 advanced from the beginning winding of the third set a 5-phase windings, S3, finishing at F4. And a fifth phase of the 5-phase winding is similarly wound beginning at S5 which is two stator slots 52 advanced from the beginning winding of the fourth set a 5-phase windings, S4, finishing at F5.

As illustrated in FIG. 5, the winding pattern is reverse progressive wind and any number of turns can be selected for winding around the groups of five stator slots 52. The windings for each phase need only maintain the appropriate relative spacing, or offset, and for practicality, the ends of the copper wires 58 are kept close together for tying which can be in a star connection configuration 50 as illustrated in FIG. 3 or in a pentagon connection configuration 52 as illustrated in FIG. 4. With this winding arrangement twelve coils per phase are created, 60 teeth/5 slots.

Accordingly the above five phase stator AC generator embodiments utilize a reduced number of slots 42 vis-a-vis a dual three-phase type machine and require two fewer diodes. In addition, there is a reduced ripple vis-a-vis a conventional 3-phase generator on the generator output.

It should also be understood that such machines can be wound, as with conventional three phase machines, in a full or short pitch configuration. In a short pitch winding configuration the coil of wire 58 is not wound around five teeth 54 but may be wound around fewer than five teeth. This serves the purpose of reducing various airgap MMF harmonics and reducing machine noise as well as providing for a potential reduction in stator phase resistance from the shorter winding end turn length.

The five phase machine is applied to a rectifier bridge 48 as shown in FIG. 3. Such a machine is configured in a manner much like a three phase machine, but with the use of ten diodes 70 rather than the typical six.

Because this armature winding 46 is constructed by connecting the five winding phase portions S1/F1 to S5/F5 into an annular shape, third harmonic components in the electric current are reduced compared to cases where an armature winding is constructed by star-connecting three winding phase portions, enabling electromagnetic noise to be reduced, and direct-current output current is greater, improving efficiency.

Moreover, in this dynamoelectric machine 200, because ripple factor can also be reduced compared to alternators adopting star-connected three-phase armature windings in a similar manner to alternators adopting conventional star-connected five-phase armature windings, rectified ripple voltages are reduced, reducing adverse effects on the electric load of a vehicle, and also enabling increased output.

Although shown in a star shaped configuration in FIG. 3, it will be recognized that the 5-phase windings 46 can be connected in alternative patterns, including, for example, forming a pentagon as in FIG. 4. The 5-phase winding 48 reduces some of the magnetically induced harmonic content of the stator 4 that produces the undesirable magnetic noise, while producing higher outputs with higher efficiency. Therefore, the technical benefits realized by a field rotor composed of more than two flux carrying segments and a stator winding consisting of 5 phases is significant increases output and efficiency capability and at the same time significant reduction in magnetic noise in a very cost effective manner.

While the exemplary twin coil claw pole rotor and five-phase stator has been described for use with generators associated with vehicles, the same may also be used and incorporated in applications other than generators for a vehicle where enhancement in electrical generation efficiency and reduction of magnetic noise is desired.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims.

1. A dynamoelectric machine comprising:
a stator including a stator winding consisting of five phases, said stator winding inserted in a plurality of slots defining said stator; and
a rotor rotatable within said stator, a rotor composed of more than two flux carrying segments, each segment having P/2 claw poles, wherein P is an even number.

2. The machine of claim 1, said stator winding is operably connected to a corresponding five-phase rectifier.

3. The machine of claim 2, wherein said five-phase rectifier is a five-phase full-wave rectifier including five diode pairs connected in parallel, each diode pair of said five diode pair including a positive-side diode d₁ and a negative-side diode d₂ connected in series.

4. The machine of claim 1, wherein a coil winding is disposed intermediate each of said more than two flux carrying segments.

5. The machine of claim 4, wherein each coil winding is energized providing a first magnetic polarity on outbound claw poles defining said rotor and a second polarity opposite said first polarity on claw poles intermediate said outbound claw poles.

6. The machine of claim 1, wherein permanent magnets are disposed between said each segment to enhance at least one of output and efficiency.

7. The machine of claim 1, wherein said stator winding consisting of five phases are connected in one of a star connection and a pentagon connection.

8. An alternating current (AC) generator for a motor vehicle comprising:
a stator including a stator winding consisting of five phases, said stator winding inserted in a plurality of slots defining said stator; and
a field rotor composed of more than two flux carrying segments, each segment having P/2 claw poles, wherein P is an even number.

9. The generator of claim 8, said stator winding is operably connected to a corresponding five-phase rectifier.

10. The generator of claim 9, wherein said five-phase rectifier is a five-phase full-wave rectifier including five diode pairs connected in parallel, each diode pair of said five diode pair including a positive-side diode d₁ and a negative-side diode d₂ connected in series.

11. The generator of claim 8, wherein a field coil winding is disposed intermediate each of said more than two flux carrying segments.

12. The generator of claim 11, wherein each field coil winding is energized providing a first magnetic polarity on outbound claw poles defining said field rotor and a second polarity opposite said first polarity on claw poles intermediate said outbound claw poles.

13. The generator of claim 8, wherein permanent magnets are disposed between said each segment to enhance at least one of output and efficiency.

14. The generator of claim 8, wherein said stator winding consisting of five phases are connected in one of a star connection and a pentagon connection.
